(19) United States
(12) Patent Application Publication
(10) Pub. No.: US 2012/0139756 A1
(43) Pub. Date: Jun. 7, 2012

(54) Height warning system

(76) Inventor: Ismet N. Djurkovic, New York, NY (US)

(21) Appl. No.: 13/373,543

(22) Filed: Nov. 17, 2011

Related U.S. Application Data
(60) Provisional application No. 61/458,144, filed on Nov. 18, 2010.

(51) Int. Cl. G08G 1/09

(52) U.S. Cl. 340/905

(57) ABSTRACT

A multi-sensory height warning system for informing a driver of a motor vehicle of the proximity of an overhead obstruction in the path of the vehicle that will contact the vehicle that has:

(a) a stationary height measuring device that is activatable by a passing vehicle that exceeds a predetermined height
(b) a signal generator connected to the stationary height measuring device that is activated by the stationary height measuring means when a passing vehicle exceeds a predetermined height and subsequently activates a warning sound generator and lights; and
(c) an overhead physical barrier that is spaced across the roadway a distance after the position of the plurality of lights.

### CROSS-REFERENCE TO RELATED APPLICATIONS

This application claims the benefit of provisional application Serial No. 61/458,144, filed, Nov. 18, 2010.

### STATEMENT REGARDING FEDERALLY SPONSORED RESEARCH OR DEVELOPMENT Not Applicable

### INCORPORATION-BY-REFERENCE OF MATERIAL SUBMITTED ON A COMPACT DISK

Not Applicable

### REFERENCE TO A MICROFICHE APPENDIX

Not Applicable

### BACKGROUND OF THE INVENTION

1) Field of the Invention

This invention relates to a system for determining the height of a motor vehicle and providing a warning to the driver of the motor vehicle when the height of the motor vehicle exceeds the

2) Description of Related Art

The problem of vehicles, such as trucks, hitting overhead obstructions has become greater in recent years. These obstructions are usually low bridges that are sized only for passenger cars or to accommodate agricultural vehicles. In soime states, some limited access highways are reserved for passenger cars and the bridges are not sized to allow busses and trucks to use the highway. The use of signs prohibiting commercial vehicles from using these roads has not eliminated this safety problem which also leads to long delays when a crash takes place or it is necessary to back a commercial off of the highway. The frequency of these crashes has increased for a variety of reasons.

First, there are more trucks and busses on the nation's highways, owing to the continued switching of railroad freight to truck freight. Hence, a greater number of trucks on the road equals a greater number of accidents involving the roofs of the truck trailer body hitting low bridges;

Second, there are more independent truckers who own their own vehicles who frequently drive cargo in trailers of varying heights. Accordingly, if a trucker is not familiar with the actual height of the trailer he or she is driving, or is unaware that the trailer has a higher than standard height, the potential for an accident involving hitting an overhead object increases.

Third, many truckers operate their trucks in unfamiliar areas where they are unaware of local conditions and thus they fail to note warning signs as they are more concerned with traffic conditions and maintaining a schedule than monitoring the height of bridges;

Fourth, the interstate highway system with standard high-clearance bridges has caused a relaxation in a trucker's need to constantly be vigilant for low clearance bridges. Other causes include bridges that were constructed with arched supports, where the arch has its highest point above the ground in the middle of the bridge that passes over the roadway that the trucker will traverse and low points at each of the far left and right sides of the arch. This arch construction itself poses some difficulties as the driver may be familiar with modern bridges having a substantially horizontal, fixed bridge height relative to the road underneath, and may not appreciate that arched bridges present an obstacle of varied height. In addition, given that trucks usually travel in the right lane, ane arched bridge presents a lower profile in the right lane which may be lower than the top of the right side of the trailer body.

Finally, the posting of bridge heights on a bridge gives little or no advance warning of the low height of a bridge, particularly when the truck is traveling at speeds in excess of 50 miles per hour.

In the prior art, systems for avoiding collisions between vehicles and overhead obstructions have attempted to eliminate the problem in a number of ways:

U.S. Pat. No. 5,389,912 disclosed a vehicle mounted system for detecting the height of a vehicle using ultrasound waves that are focussed in front of the vehicle.

U.S. Pat. No. 3,232,265 disclosed a vehicle mounted height clearance indicator which includes a flexible, antenna-like height indicator which physically contacts an overhead object and provides a relatively direct indication of the height of the object by mechanical means. Although this clearance indicator is useful owing to its functioning without an electrical supply, a drawback of this device is that it will wear over time given its direct physical contact with obstructions.

U.S. Pat. No. 4,284,971 disclosed an overheight vehicle detection and warning system which is installed along a roadway to measure the vehicle height as it passes the system, and illuminates a warning sign telling the driver of the truck to stop if the vehicle height is greater than an approaching bridge. There is no meaning other than the warning sign that communicates the height indication to the driver.

U.S. Pat. No. 4,789,941 is concerned with a system which uses a computerized vehicle classification system that calculates the height of the vehicle in order to classify the vehicle for toll collection or traffic control purposes. This system is inapplicable for determining the absolute heights of vehicles, as this system rejects the height of the vertical exhaust pipe of a truck, for example, as an anomalous reading because it is not concerned with the absolute height of vehicles, but rather with the classification of the vehicle.

U.S. Pat. No. 4,015,232 disclosed a vehicle mounted ultrasonic distance detector for vehicles that tells the driver how close portions of the vehicle are to horizontally spaced objects such as the distance from a wall to truck bumper.

Other means for alerting a driver to a low clearance obstacle that have been used include signs, horns activated by a horizontal height measuring beam and suspended hard objects such as pipes on chains that will strike the top of an oversize vehicle without causing major damage to the vehicle.

Accordingly, there is a need for a simple, accurate device which can be positioned on a roadway to alert the driver of the vehicle by using sight, sound and a physical barrier that there is a low obstacle such as a bridge in the path of his vehicle.

The use of the terms “vehicle” and “truck” is for convenience only, as all types of vehicles which are moved relative to overhead objects, such as trucks, buses, recreational vehicles (RVs), cranes, excavators, construction apparatus, towing vehicles and the like are intended to be within the scope of the invention.

### BRIEF SUMMARY OF THE INVENTION

The present invention is a multi-sensory height warning system for informing a driver of a motor vehicle of the proximity of an overhead obstruction in the path of the vehicle that will contact the vehicle, where said system comprises:

(a) a stationary height measuring means that is positioned adjacent to the roadway in advance of the obstruction across the roadway, said stationary height measuring device being activatable by a passing vehicle that exceeds a predetermined height
(b) a signal means connected to the stationary height measuring means that is activated by said stationary height measuring means when a passing vehicle exceeds a predetermined height where said signal means is adapted to make an audible sound and to energize a plurality of lights positioned a distance after the position of the stationary height measuring means; and
(c) an overhead physical barrier that is spaced across the roadway a distance after the position of the plurality of lights.

The multi-sensory warning system is designed to get the attention of a driver to the urgency of the need to stop his vehicle to avoid damage and injury to himself and others by the combined use of sight, sound and a physical barrier.

It is a first object of the invention to provide a multi-sensory system for warning a driver of a motor vehicle that there is an obstruction in the path of his vehicle that is too low for the vehicle to pass under without contacting the obstruction.

It is also an object of this invention to provide a multi-sensory warning system that alerts the driver of a vehicle by sight, sound and contact of the proximity of an overhead obstruction.

It is also an object of the invention is to reduce traffic delays that are caused by the need to back vehicles away from obstructions that will not allow the vehicle to pass without damaging the vehicle.

It is also an object of the invention to provide an anti-height detection and warning system that may be easily installed at low cost and will require a minimum of maintenance.

It is also an object of the invention to provide a height detection system that does not require an operator and will operate automatically in all types of weather and cannot be disabled by motor vehicle operators as it is not mounted on the vehicle.

These and other objects and advantages of the invention will be readily apparent in view of the following description and drawings of the above-described invention.

### BRIEF DESCRIPTION OF THE SEVERAL VIEWS OF THE DRAWINGS

FIG. 1 is a top plan view of an access road to a limited access highway dedicated to passenger cars which shows a truck entering a multi-sensory warning system according to the invention. receiving an ultrasonic wave generated by the ultrasonic wave

FIG. 2 is a schematic arrangement of the system of the invention viewed from the perspective of the rear of a vehicle which is approaching the multi-sensory warning system

### DETAILED DESCRIPTION OF THE INVENTION

The multi-sensory height warning system may be mounted on a road in advance of any obstacle that may interfere with oversized vehicles. In particular, the system is adapted to be positioned at the entrance to limited access highways. The term oversized vehicle is used to describe vehicles which are higher than the highest passenger cars and are typically over 9 feet in height.

The stationary height measuring means comprises any type of an automatic device that detects the height of an object. The device may be based on a laser beam, light beam, magnetic beam, sonar beam, ultrasound beam or the like that is interrupted by a object. The beam is positioned at a predetermined height and causes a signal to be generated by a computer or an electrical relay that activates a sound generating device and energizes a plurality of illuminating devices.

For example, an ultrasonic wave generating means and the ultrasonic wave receiving means may be positioned at a predetermined height that is derived from the height of an obstruction or bridge that is in proximity to the location of the stationary height measuring system. The ultrasonic wave generating means is designed to transmit a substantially horizontal ultrasonic wave, with vertical difference measuring means operatively connected to the ultrasonic wave generating means and to the ultrasonic wave receiving means for determining if the vertical height of a vehicle exceeds a predetermined maximum height. In addition, separate signal generating means are operatively connected to the vertical difference determining means to provide sound and illumination.

A conventional ultrasonic wave generating and receiving apparatus that includes an ultrasonic wave transmitter transducer and an ultrasonic wave receiver transducer, such as a SONIN 60 Electronic Tape Measure, is produced by Sonin Inc. of Scarsdale, N.Y. As will be readily understood, a computer device, such a conventional microprocessor, or chip will process the electronic signals generated by the ultrasonic wave transducer(s) and transmit a signal to activate a sound generating device and/or energize a plurality of illuminating devices.

Other laser beam, light beam or magnetic beam based systems may be used as detectors to determine if a vehicle passing through the stationary height measuring means, exceeds a predetermined height.

After a vehicle is determined to be oversized, a signal is generated to cause a sound generating device to alert the driver to the obstacle in the path of the vehicle. The sound may be a continuous or non-continuous noise generated by a device such as a horn, siren, buzzer or recorded announcement. At the same time, lights will be illuminated that are placed in front of the location of the stationary height measuring means. These lights may be mounted on a plurality of posts that are spaced apart on both sides of the road. Flashing colored lights are the preferred type of illuminating devices but stroboscopic, LED or other high intensity forms of light may also be used.

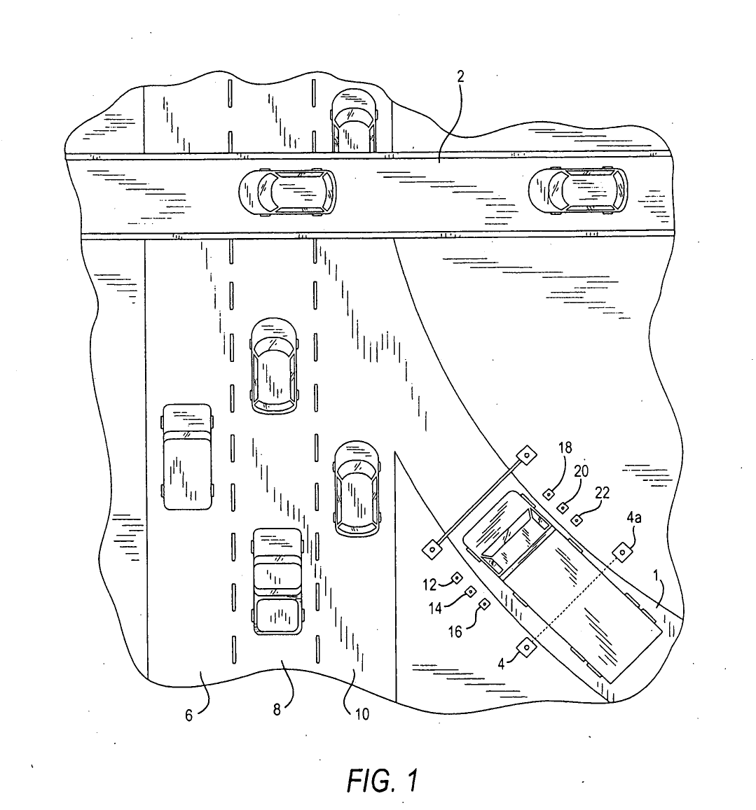

FIG. 1 is a diagram of how the system of the invention may be positioned on an access ramp 1 of a limited access highway where a bridge 2 is sized only to accommodate passenger cars. A beam 3 is passed from beam generator 4 is positioned across the access ramp 1 opposite a beam receiver 4a at a level that is set at or below the maximum clearance that bridge 2 provides over first travel lane 6, second travel lane 8 and third travel lane 10. Spaced ahead of the beam generator 4 and the beam receiver 4a are lights 12, 14, 16, 18, 20 and 22. Six lights are shown with three lights on each side of the road but the number of lights may be varied depending on any curvature in the road or local conditions such as fog.

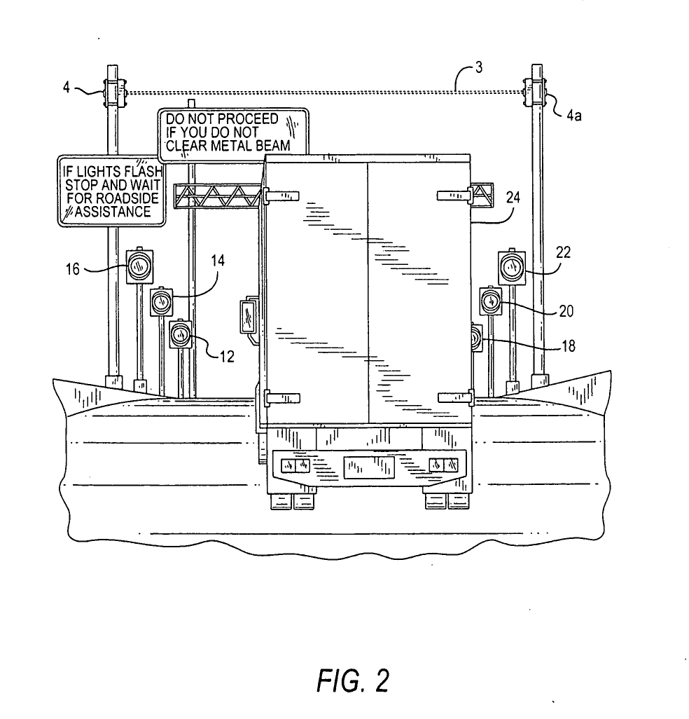

The lights are preferably mounted on posts of different heights that are placed on both sides of access ramp 1 in front of the beam 3 so that the lights will be plainly visible from the drivers seat so that the attention of the driver will be directed to the urgency of the sound and signs that are positioned to inform the driver of the immediacy of the obstacle that can damage the vehicle. The lights are wired into a circuit that is automatically activated by the stationary height measuring means that are preferably arranged on posts of increasing height as they are spaced further away from the point at which the beam generator 4 and beam receiver 4a are mounted. As shown in FIG. 2, flashing lights are placed on posts with a rectangular background plate that provides day time contrast for the flashing lights that are activated when an oversize vehicle interrupts beam 3. The flashing lights are preferably set on a first row of posts 16,22 that are six to nine feet high and preferably eight feet high and are set 20 to 30 feet and preferably 25 feet from the beam 3; the second row of posts 14,20 are eight to ten feet high and preferably nine feet high and are set about ten to 15 feet from the first row off posts; and the third row of posts are nine to 11 feet high and preferably 10 feet high and are set 10 to 15 feet from the second row of posts. Alternately, one or more additional overhead flashing lights may be positioned on a bar in register with one of the rows of posts for the purpose of providing an additional flashing light directly in front of the driver's line of vision.

The system also may include conventional warning signs that advise the driver of the proximity and height of the obstruction and provide directions to back up or summon assistance. An alternate embodiment will comprise a communication means that is automatically activated by the oversize vehicle detection system to alert police of the activation of the oversized vehicle detection system.

The third element of the multi-sensory height warning system is an overhead physical barrier 24 that is spaced across the roadway a distance after the position of the flashing lights. The physical barrier may be a rigid wooden, metal or plastic structure that is sized and structured so that if it is contacted by a vehicle it will make as loud a noise as possible to serve as a fail-safe alerting means in the event that the driver is unable to discern the sound and flashing lights that are triggered when the vehicle passes through the beam of the oversize height detector. FIG. 2 shows a cross-connected metal beam 24 that is positioned over the roadway. Other physical barriers may be hollow pipes or box beams that are designed to make a loud noise when contacted by a vehicle. The physical barrier will be positioned at about the same height as beam 3 to so that it will contact any vehicle that is too high to pass under the next obstacle or bridge in the path of the vehicle.

1. A multi-sensory height warning system for informing a driver of a motor vehicle of the proximity of an overhead obstruction in the path of the vehicle that will contact the vehicle, where said system comprises:
(a) a stationary height measuring means that is positioned adjacent to the roadway in advance of the obstruction across the roadway, said stationary height measuring means being activatable by a passing vehicle that exceeds a predetermined height
(b) a signal means connected to the stationary height measuring means that is activated by said stationary height measuring means when a passing vehicle exceeds a predetermined height where said signal means is adapted to make an audible sound and to energize a plurality of lights positioned a distance after the position of the stationary height measuring means; and
(c) an overhead physical barrier that is spaced across the roadway a distance after the position of the plurality of lights.

2. The multi-sensory height warning system as defined in claim 1 where the stationary height measuring means comprises a laser beam, light beam, magnetic beam, sonar beam or ultrasound beam.

3. The multi-sensory height warning system as defined in claim 1 where the plurality of lights comprise flashing lights mounted on post of varying height.

4. The multi-sensory height warning system as defined in claim 3 where the plurality of lights are arranged opposite one another on both sides of the roadway.

5. The multi-sensory height warning system as defined in claim 3 where the means adapted to make an audible sound comprises a continuous or non-continuous sound.

6. The multi-sensory height warning system as defined in claim 5 where the sound is generated by a horn, siren, buzzer or recorded announcement.

7. The multi-sensory height warning system as defined in claim 3 wherein the overhead physical barrier is spaced across the roadway a distance after the position of the flashing lights.

8. The multi-sensory height warning system as defined in claim 3 where the physical barrier is a rigid wooden, metal or plastic structure.
